(19) United States
(12) Patent Application Publication
(10) Pub. No.: US 2015/0186612 A1
(43) Pub. Date: Jul. 2, 2015

(54) METHOD AND APPARATUS FOR DISTINGUISHING USER HEALTH-RELATED STATES BASED ON USER INTERACTION INFORMATION

(71) Applicant: HERE Global B.V., Veldhoven (NL)

(72) Inventors: Ilya Gartseev, Moscow (RU); Marc Bailey, Cambridge (GB); Oleg Tishutin, Moscow (RU)

(21) Appl. No.: 14/577,738

(22) Filed: Dec. 19, 2014

(30) Foreign Application Priority Data
Dec. 30, 2013 (RU) 2013158603

(51) Int. Cl. G06F 19/00; H04W 4/00

(52) U.S. Cl. CPC G06F 19/3418; H04W 4/001

(57) ABSTRACT

An approach is provided for distinguishing between various user health-related states based on user interaction information from mobile devices. The state platform may process and/or facilitate a processing of user interaction information associated with at least one device to determine one or more cognitive features of at least one user. Then, the state platform may cause, at least in part, a calculation of one or more feature vectors based, at least in part, on the one or more cognitive features. Then, the state platform may determine at least one current health-related state associated with the at least one user based, at least in part, on the one or more feature vectors.

### BACKGROUND

Service providers and device manufacturers (e.g., wireless, cellular, etc.) are continually challenged to deliver value and convenience to consumers by, for example, providing compelling network services. One area of interest has been the development of connecting devices to respond to mental and physiological states. For example, users often interact with a host of devices and systems such that devices may continuously observe user behavior via sensor information available as part of device capabilities. In other words, patterns of device usage that are indicative of user states or deviations from normal patterns of usage are available as sensor information. Devices are also available that specifically monitor one aspect of user behavior and render their findings. For instance, pedometers or blood pressure sensors are dictated to follow and record essentially one measure of user health. However, general mobile devices often do not connect collected sensor information with indications of a user's present state. Therefore, content providers face challenges in determining a user's health-related state with capabilities based only on information from a device associated with the user.

### SOME EXAMPLE EMBODIMENTS

Therefore, there is a need for and added value from an approach for distinguishing between various user health-related states based on user interaction information.

According to one embodiment, a method comprises processing and/or facilitating a processing of user interaction information associated with at least one device to determine one or more cognitive features of at least one user. The method also comprises causing, at least in part, a calculation of one or more feature vectors based, at least in part, on the one or more cognitive features. The method further comprises determining at least one current health-related state associated with the at least one user based, at least in part, on the one or more feature vectors.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of user interaction information associated with at least one device to determine one or more cognitive features of at least one user. The apparatus is also caused to cause, at least in part, a calculation of one or more feature vectors based, at least in part, on the one or more cognitive features. The apparatus is further caused to determine at least one current health-related state associated with the at least one user based, at least in part, on the one or more feature vectors.

According to another embodiment, a computer-readable storage medium carries one or more sequences of one or more instructions which, when executed by one or more processors, cause, at least in part, an apparatus to process and/or facilitate a processing of user interaction information associated with at least one device to determine one or more cognitive features of at least one user. The apparatus is also caused to cause, at least in part, a calculation of one or more feature vectors based, at least in part, on the one or more cognitive features. The apparatus is further caused to determine at least one current health-related state associated with the at least one user based, at least in part, on the one or more feature vectors.

According to another embodiment, an apparatus comprises means for processing and/or facilitating a processing of user interaction information associated with at least one device to determine one or more cognitive features of at least one user. The apparatus also comprises means for causing, at least in part, a calculation of one or more feature vectors based, at least in part, on the one or more cognitive features. The apparatus further comprises means for determining at least one current health-related state associated with the at least one user based, at least in part, on the one or more feature vectors.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of distinguish between various user health-related states based on user interaction information from mobile devices, according to one embodiment;

FIG. 2A is a diagram of the components of a state platform, according to one embodiment;

FIG. 2B is a diagram of the components of a vector module, according to one embodiment;

FIG. 3 is a flowchart of a process for distinguishing between various user health-related states based on user interaction information, according to one embodiment;

FIG. 4 is a flowchart of a process for determining normal health-related states, according to one embodiment;

FIG. 5 is a flowchart of a process for updating the health-related states, according to one embodiment;

FIG. 6 is a flowchart of a process for determining the likelihood of current health-related states relative to candidate health-related states, according to one embodiment;

FIG. 7A is a diagram of a general description of system 100, according to one embodiment;

FIG. 7B is a graph of extracting features from typing user interaction information, in one embodiment;

FIG. 7C includes models of differences in keystroke accuracy for different health-related states, as projected onto a mobile device, according to one embodiment;

FIG. 7D is a graph of how different states may appear in a two-dimensional feature space including mean and standard deviation values, according to one embodiment;

FIG. 8A is a diagram for the classification procedure, according to one embodiment;

FIG. 8B is a diagram of user interfaces for modifications to privacy profiles, according to one embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for distinguishing between various user health-related states based on user interaction information from mobile devices are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

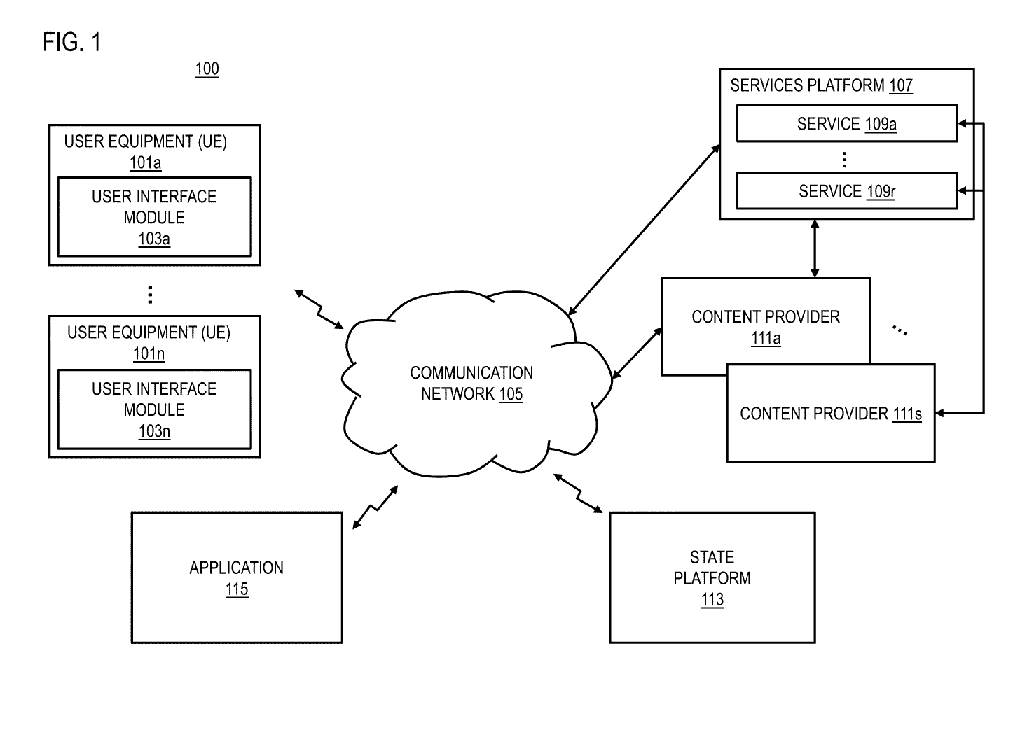

FIG. 1 is a diagram of a system capable of distinguishing between various user health-related states based on user interaction information from mobile devices, according to one embodiment. Service providers and device manufacturers (e.g., wireless, cellular, etc.) are continually challenged to deliver value and convenience to consumers by, for example, providing compelling network services. One area of interest has been the development of connecting devices to respond to health-related states. For example, users often interact with a host of devices and systems such that devices may continuously observe user behavior via sensor information available as part of device capabilities. In other words, information regarding patterns of usage or deviations from patterns of usage is available as sensor information. Devices are also available that specifically monitor one aspect of user behavior and render their findings. For instance, pedometers or blood pressure sensors are dictated to follow and record essentially one measure of user health. However, general mobile devices often do not connect collected sensor information with indications of a user's present state. Therefore, content providers face challenges in determining a user's state of mental or physiological capabilities based only on sensor information from a device associated with the user.

To address this problem, a system 100 of FIG. 1 is capable of distinguishing between various user health-related states based on user interaction information from mobile devices, according to one embodiment. In one embodiment, system 100 makes the determination without any additional services or devices. For instance, a mobile device (i.e., a mobile phone, portable tablet, smart watches, communication devices with touch screens and/or key boards, motion sensors, etc.) may identify a user's health-related state simply using the sensors and/or any built-in software application(s) built into the mobile device. External sensors, devices, and/or chemical tools for determining a user's state are not necessary. For instance with a glucometer, a drop of blood from the user is necessary to obtain a reading and determination of the user's state. In one embodiment, a mobile phone is sufficient for detecting a user's state. Similarly, in one embodiment, user interaction is not required for a determination of the user's state. For example with the glucometer, a user would need to provide a drop of blood. With system 100, however, sensor information and analysis from a portable device is all that is needed for a determination. Prompting, user requests, or conscious provision of information from a user is not necessary for system 100 to render a determination.

In one embodiment, health-related states of users may include 1) intoxication, 2) medical condition, and/or 3), general inattention. For example, intoxication may involve mental impairment from consumption of drug, alcohol, substance, chemicals, etc. A medical condition may include painful, diagnosed, undiagnosed, acute or chronic health conditions. For instance, seizures, muscle spasms, sensations of pain, etc. General inattention may describe conditions including distraction, fatigue, drowsiness, anger/agitation, etc.

To distinguish between various health-related states, the system 100 may create and/or employ various learning algorithms that process features to estimate the state of a person. For example, system 100 may generate a vector of features that describe the state of a user, as given by sensor information from a device associated with the user. The vector of features may comprise a vector incorporating various features that serve as indications or clues as to a user's potential state. System 100 may then apply learning and statistical algorithms to the feature vector to classify a user's condition into a known state and compute the probability that the user is in a predetermined state, for example, 1) intoxication, 2) experiencing a medical condition, or 3) general inattention. Statistical algorithms may include expected values or default values where a given set of sensor information is likely to indicate a certain health-related state over another. System 100 may base the statistical algorithms on known behavioral models, consumer information, etc., where the models and information may describe people in general or users that share some similarities to the user. For instance, system 100 may apply statistical algorithms based on a user's particular demographic. Learning algorithms may be specific to a user's habits and behavior. For example, system 100 may constantly update learning algorithms (and statistical algorithms) to follow the history of user behavior and outcomes such that the algorithms may accurately analyze users' health-related states based on user interaction information from mobile devices.

The features that serve as indications or clues as to a user's potential state may include user interaction information associated with at least one device. For example, user interaction information may include interaction related to a user's keystrokes on a keyboard (i.e., a virtual keyboard). In one instance, accuracy of keystrokes, typing speed for typical symbol combinations, relative number of mistyped symbols in words compared to thesaurus statistics, relative number of mistyped symbols in the form of “backspace” key usage, and hand movement analysis may all comprise user interaction information. Accuracy of keystrokes may refer to where a user's finger strikes a key. For instance, a user in a normal state may typically press keys near the center of a key. However, an intoxicated user may, more often, strike the edges or a key or swipe across a key. Typing speed for typical symbol combinations may include analyzing how quickly a user typically types, relative to deviations in the user's typing speed. For example, a user may type more slowly than usual if he is walking or driving while trying to text.

The system 100 may determine or analyze typographical errors or mistyped symbols via thesaurus statistics or detection of a user pressing the “backspace” key, for example. Determining mistyped symbols via thesaurus statistics may include determining common misspellings. For example with texts, “they're” may often be typed as “theyre.” System 100 may define or recognize “they're” and “theyre” as synonyms in the context of text conversations. Thesaurus statistics may include determine how often the misspellings occur, especially for a particular user. For example, if a user typically interchanges “they're” and “theyre” while communicating, an extensive use of “theyre” may not indicate a state change for that user. However, if the user consistently uses “they're” and system 100 detects a spike in usage of “theyre,” system 100 may increase monitoring to determine if the user has deviated from his normal state. In other words, system 100 takes data from words the user has completed typing. Determining mistyped symbols from the user pressing the “backspace” key means that the system 100 may also analyze words a user may not complete typing. For instance, an increase in a user's use of “backspace” may be an indication of intoxication since the user must try harder to type the message he wishes to convey.

In a further embodiment, features may include context information, sensor information, or a combination thereof. In one embodiment, features may include cross-correlating user interaction information keyboard keys and input from microelectromechanical (MEMS), for example, accelerometers and gyroscopes. For example, keyboard interaction information paired with sensor data from MEMS may give indication to hand movements. For instance, this feature may determine whether a user is moving erratically based on his hand movements. Erratic movement may indicate the user being in a state associated with a medical condition. In another instance, the feature may detect whether a user is typing with one hand or both hands. In one case where a user typically types with both hands, typing with one hand may trigger the system 100 to interpret the interaction as evidence that the user may be affected somehow by a medical condition.

MEMs may also simply provide information on a device's movement, independent of user hand movement. For instance, information from MEMs information may show whether a phone is being physically dropped (then picked up) frequently in a short span of time. A user that keeps dropping her phone, especially while typing, may be intoxicated. In a further embodiment, sensor information and/or context information may include information regarding location or point of interest analysis. For instance, system 100 may recognize that if a user is at a pub or bar for a period of time, an increase in unusual keystroke data from user interaction information is more likely an indication of a user being increasingly intoxicated, rather than the user suffering the onset of a medical condition.

In addition in another embodiment, sensor information may include audio information, for instance, via a microphone. This analysis may include audio environment analysis where the system 100 may conclude that a user is likely at a bar if system 100 detects a loud decibel level. With a combination of factors, this likelihood of being at a bar may give stronger indication that intoxication explains a user's irregular user interaction information. System 100 may further analyze audio information with intonation and mood detectors. For example, system 100 may determine if a user is speaking in a fashion that is slurred or loud or rapid. With this determination, system 100 may supplement analysis for the vector regarding which state a user may be in. Analysis of audio information may further include vocabulary and word usage frequencies analysis. For example, system 100 may have certain trigger words or simply monitor the frequencies of certain words that a user either says or is told. Based on those words, system 100 may infer a state that a user is more likely to be in. For instance, a user using profuse profanity may be intoxicated, rather than in a normal state or undergoing a medical condition, depending on how the user typically uses profanity. The same analysis of vocabulary and word usage frequencies may be applied to text messages and/or emails sent by the user. In one embodiment, system 100 may further perform a step of selecting from the various possible analytical approaches, including analysis of user interaction information, audio information, etc. For example, system 100 may determine when a user's audio environment reaches a total noise input that is sufficient enough to constitute significance towards determining a health-related state. For example, audio environments may fluctuate. Within a certain range, system 100 may not cause audio information analysis unless total noise input reaches a significant deviation from a normal input. As part of the selection, system 100 may also determine values or ranges of values that constitute significance. System 100 may further determine where vocabulary and word usage frequency shows a deviation from a given user's common word usage. Depending on analyses that yield significance or meaning in the determination of a health-related state, system 100 may select analytical approaches to further enact.

In one embodiment, system 100 may generate one or more feature vectors from the features discussed above. Then, the system 100 may process the feature vectors to classify a user's state into at least one current health-related state. In one embodiment, system 100 may generate or determine which feature vectors to generate based on resources availability information, device capability information, or a combination thereof associated with at least one device. For example, system 100 may only use audio information analysis and not analyze features of text messages and emails, depending on power consumption constraints of a device. To lower power consumption, system 100 may select a subset of features (from which to generate feature vectors) in order to determine any deviations from a normal state. In one embodiment, system 100 may create a threshold where system 100 recognizes the deviation from normal state as significant. Then, system 100 may initiate determination or creation of more feature vectors in order to determine a user's state.

In one embodiment, system 100 may determine 1) similarities between various health-related states and 2) fine distinctions in user interactions and other sensor information from mobile devices that may distinguish between various the health-related states. In a further embodiment, system 100 may determine classifications of the mental and/or physiological states specific to each user. In monitoring a user, system 100 may continuously refine and update feature vectors that may dictate classifications such that classifications may increasingly, accurately reflect a specific user's health-related state.

As a further embodiment, system 100 may cause device actions based on the determination of a user's state. For instance, a user in an intoxicated state may make impulsive shopping decisions, want to make phone calls, or attempt to drive a car. The system 100 may deploy various device actions and/or execute actions in conjunction with other devices or services in response to the determination of a user's state. For instance, device actions in response to a determination that a user is in an intoxicated state may include 1) ordering a taxi automatically, 2) notifying a friend of the user, 3) increasing advertising for shopping, taxis, pubs, etc., and/or 4) emitting a warning to the user (or other parties) if the user attempts to drive.

Executing actions in conjunction with other devices may include the notification to a friend, for instance, where the system 100 may have the capability to access a device associated with a user's friend to deliver the notification. Acting in conjunction with another device may also include, for instance, putting a user's key or vehicle in a “locked” mode so the vehicle cannot be driven if system 100 detects an intoxicated user attempting to drive. For example, system 100 may determine that a user identified as being in an intoxicated state is attempting to start the ignition of his vehicle. The system 100 may then communicate with the vehicle to prevent the vehicle from starting. Acting in conjunction with services may include the examples with contacting a taxi service or increasing advertising. The services may further include preventing a user from successfully completing a purchase or completing purchases of predetermined types after detecting a user state. For instance, where system 100 determines that a user is very intoxicated, the system 100 may contact a service that prevents the user from buying luxury goods or more alcohol, where the goods and alcohol are examples of predetermined types of purchases.

In an example where a user is detected to have a medical condition, however, device actions may be different. For example, system 100 may prompt calling a hospital or aiding driving, rather than preventing driving. Meanwhile, general inattention of a driver may not cause the system 100 to launch any specific actions. Rather, the system 100 may simply heighten monitoring, in one example, for where the user state may escalate to where system 100 may deploy device action. For example, system 100 may not cause device actions where a user is simply distracted. However, if a user's distracted state looks more like fatigue, system 100 may deploy some device action, for example, a sound or light impulse to wake up the user.

In one embodiment, system 100 may run without a user's knowledge. In another embodiment, system 100 may run and determine a user's current health-related state, wherein the user is the only party that receives results of system 100's determination. In yet a further embodiment, system 100 may send results of system 100's determinations as to a user's current health-related state to one or more trusted parties. Such parties may include, for example, a user, a user's family, a user's medical doctor, or a combination thereof. In one embodiment, system 100 may even analyze aggregate data. For instance, system 100 may observe that a user appears to be in an intoxicated state more often than a typical user. In this case, system 100 may increase monitoring and/or perform an action if the detected health-related state is seen to be a progressing medical issue.

As shown in FIG. 1, the system 100 comprises a user equipment (UE) 101a-101n (or UEs 101) having connectivity to user interface modules 103a-103n (or user interface modules 103), a services platform 107 comprised of services 109a-109r (or services 109), content providers 111a-111s (or content providers 111), a state platform 113, and an application 115 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, the user interface modules 103 may provide user interaction information and other sensor information. For example, user interface modules 103 may collect information on users' keystrokes for the state platform 113 to analyze. In one embodiment, the state platform 113 may automatically receive sensor information from UEs 101, for example via application 115. In another embodiment, user interface modules 103 permit users to dictate or at least alter sensor information that is received by state platform 113. In yet another embodiment, user interface modules 103 interact with state platform 113 where user interface modules 103 may present modifications to privacy policies or data propagation policies. As an initial step, user interface modules 103 may permit users to create their initial privacy settings for how state platform 113 operates. For instance, classifications made by state platform 113 may be unknown to a user. In other instances, system 100 may inform other users, services, etc. of the user's health-related state.

In a further embodiment, user interface modules 103 may provide state platform 113 with user activity and/or context information. For instance, user activity information may include a user's activity in texting or emailing. The activity may provide, for instance, word analysis where word usage or number of typographical errors may be indicative of a state. Furthermore, user activity may include activity on a social network (e.g. posting, commenting, sharing, etc.). Context information may also be derived from user interface modules 103, for instance, where users “check in” to a location or provide a timestamp on some activity. Then, the user interface modules 103 may permit state platform 113 to construct stronger associations between the user interaction information, sensor information, contextual information, or a combination thereof, and the user's state.

In one embodiment, the services platform 107 may provide services 109 for feature vector input. For example, services 109 may include services for vocabulary and word usage analysis or audio analysis. Services platform 107 may further include services 109 that may be informed regarding a user's health-related state. For example, services 109 may include medical emergency personnel for when state platform 113 determines that a user state indicates a serious medical condition. Services 109 may further provide computations for determining probability information for classifying users' states. For instance, services 109 may include computing and processing capabilities for organizing and analyzing data.

In one embodiment, the content providers 111 may provide the generic behavioral models and/or historic user behavior from which the state platform 113 formulates candidate health-related states. For example, the content providers 111 may provide the ranges of physiological markers that generally denote particular mental and/or physiological states. For example, content providers 111 may provide a range of typing error margins that constitute an “inattentive” state versus an “intoxicated” state. In other words, content providers 111 may provide state platform 113 with the information needed to determine, from user interaction information, sensor information, and/or context information, one or more health-related states. For example, content providers 111 may contain a repository of health-related states that may form the basis of candidate health-related states and normal health-related. In one embodiment, the content providers 111 may further develop the candidate health-related states to formulate a particular user's normal health-related state, at least before the system 100 has a collection of information on a user with which to form the normal health-related state. For example, the content providers 111 may provide generic behavioral models for specific demographics, age, or gender groups.

In one embodiment, the state platform 113 may determine at least one current health-related state associated with a user based on feature vectors. In one embodiment, state platform 113 may determine user interaction information. In one instance, the state platform 113 may further supplement user interaction information with sensor information, contextual information, or a combination thereof. With the collected information, state platform 113 may determine one or more cognitive features that connect the information to possible inferences of a user's health-related state. The state platform 113 may then calculate feature vectors based on the features and classify a user's health-related state based on the calculation. The classification may form system 100's interpretation of a user's current health-related state.

In one embodiment, the application 115 may serve as the means by which the UEs 101 and state platform 113 interact. For example, the application 115 may activate upon user request or upon prompting from the state platform 113 that a health-related state change is detected. For example, application 115 may act as the intermediary through which state platform 113 receives sensor information from UEs 101 and convey notifications regarding health-related states to UEs 101 or other UEs 101 back from state platform 113.

By way of example, the UE 101, user interface modules 103, services platform 107 with services 109, content providers 111, state platform 113, and application 115 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

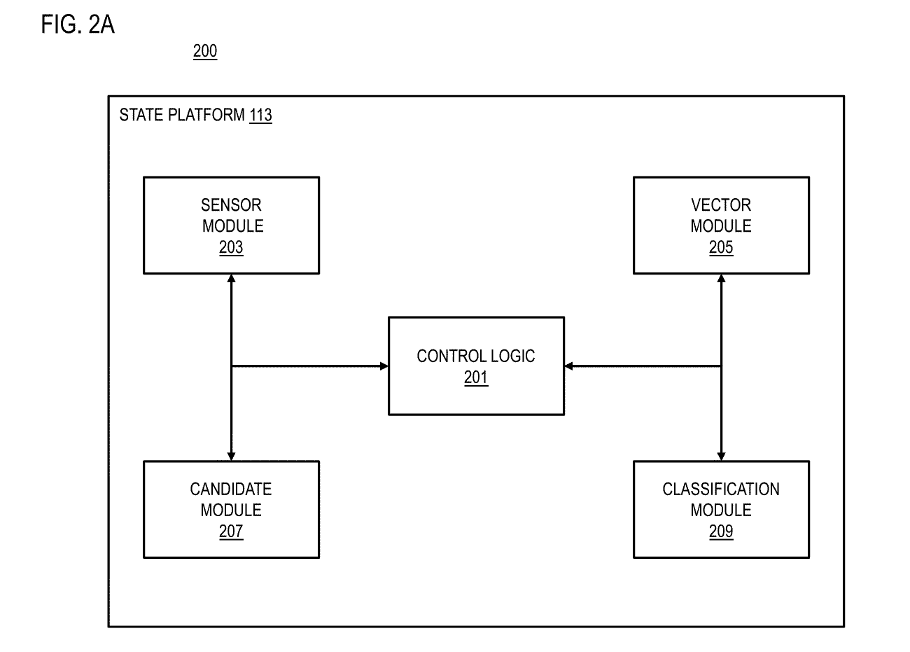

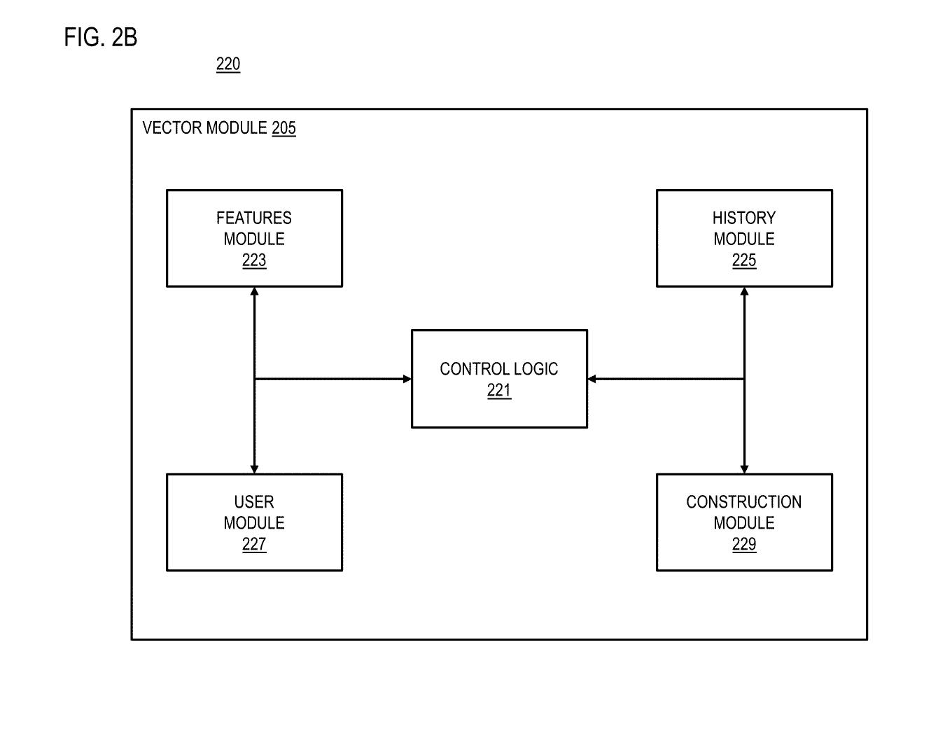

FIG. 2A is a diagram of the components of the state platform 113, according to one embodiment. By way of example, the state platform 113 includes one or more components for adapting privacy profiles to respond to changes in physiological states. It is contemplated that the functions of these components may be combined in one or more components or performed by other components of equivalent functionality. In this embodiment, the state platform 113 includes a control logic 201, a sensor module 203, a vector module 205, a candidate module 207, and a classification module 209.

In one embodiment, the control logic 201 and sensor module 203 may determine sensor information available from the UEs 101. For example, the sensor information may include keystroke information, for example, regarding keystrokes. In one embodiment, the control logic 201 and sensor module 203 may observe the accuracy of keystrokes on a virtual keyboard. Accuracy of keystrokes may involve typing speed, number of typographical errors, usage of the “delete” or “backspace” functions, keystrokes that miss the keys or the keyboard, keystrokes that fall on the borders of keys (versus in the middle of keys), keystrokes as typed by one hand or two hands, etc.

The control logic 201 and sensor module 203 may determine that sensor information may further include sensors from audio and/or camera functions of UEs 101. For example, audio information may include indications of an audio environment or word usage. Audio environment may include, for instance, indications of a user's location or environment based on sound. In one case, extremely persistent audio information at a high decibel level may indicate that a user is likely at a nightclub, concert, or sports event. Low decibel levels may tend to indicate that a user is at home or in a private setting. Word usage may input may include vocabulary or frequencies of words (or lack of words) in messages sent or voiced by a user. Intonation or mood of a user may also be part of the audio information collected by control logic 201 and sensor module 203. The control logic 201 and sensor module 203 may further gather sensor information that renders context information regarding a user. For example, context information my further include user location, time of day, temperature, etc. In one such case, temperature information may indicate whether the user's context is night or day and location information may give insight into a user's whereabouts. The context information, sensor information, and user interaction information may all overlap. The control logic 201 and sensor module 203 simply interact with UEs 101 to determine collect ongoing information on users' environments and states.

In one embodiment, the control logic 201 and vector module 205 may calculate feature vectors for a user. For example, the control logic 201 and vector module 205 may determine how sensor information from the control logic 201 and sensor module 203 are interpreted with respect to user health-related states. For example, control logic and sensor module 203 may receive user interaction information regarding a user's typing. The control logic 201 and vector module 205 may determine cognitive features, where features may include some indication of a user state. For instance, the control logic 201 and vector module 205 may create a feature vector from the user interaction information to see that a user's typographical errors are increasing. The control logic 201 and vector module 205 may construct the feature vectors particular to a user, whereupon the control logic 201 and candidate module 207 may determine a point of reference for the user feature vector for the control logic 201 and classification module 209 to form a result on a user's health-related state.

In one embodiment, the control logic 201 and candidate module 207 may determine one or more candidate health-related states. For example, users may be inflicted with a number of possible medical issues. For instance, a user may have asthma, a severe nut allergy, diabetes, etc. Then, the control logic 201 and candidate module 207 may determine each of these medical conditions as candidate health-related states. In one embodiment, the control logic 201 and candidate module 207 may further determine various thresholds or ranges of feature information that may be characteristic to each condition. For example, a user experiencing low blood sugar from diabetes may type with normal accuracy, but type and speak more far more slowly than he does at a normal state. The control logic 201 and candidate module 207 may determine candidate health-related states for the system 100 in general, for a general population of users. Alternately, the control logic 201 and candidate module 207 may generate candidate health-related states specific to a particular user or have greater development of the indications of candidate health-related states for the states that a particular user is more likely to experience.

In one embodiment, the control logic 201 and the classification module 209 may determine probability information for classifying a user into the candidate health-related states. For example, the control logic 201 and classification module 209 may determine vector information that reflects a user's normal state. Where the control logic 201 and classification module 209 detects a deviation from the normal state, the control logic 201 and classification module 209 may compare analysis from the vector module 205 with candidate state information from the candidate module 207 to make a determination of a user's current state.

In a further embodiment, the control logic 201 and the classification module 209 may determine one or more health-related substates, where the substates may serve as a threshold as to when the control logic 201 may initiate increased monitoring or more comprehensive creation of feature vectors for analysis. For example, substates may determine where deviations from a normal health-related state become significant enough to trigger increased monitoring. One such case may include a substate where a user is experiencing the effect of alcohol or mildly intoxicated. The user's speech may slow and his typing may have an increase in error rate of 5%. Here, control logic 201 and classification module 209 may determine the user to be in an abnormal state. In one embodiment, the control logic 201 and classification module 209 may then prompt an increase in monitoring to observe whether the user reaches the substate of intoxication.

FIG. 2B is a diagram of the components of the vector module 205, according to one embodiment. By way of example, the vector module 205 includes one or more components for determining feature vectors. It is contemplated that the functions of these components may be combined in one or more components or performed by other components of equivalent functionality. In this embodiment, the vector module 205 includes a control logic 221, a features module 223, a history module 225, a user module 227, and a construction module 229.

In one embodiment, the control logic 221 and the features module 223 may determine one or more features. For instance, the control logic 221 and features module 223 may determine how sensor information translates into an indication of health-related states. For instance, the control logic 221 and features module 223 may be the entities that determine that an unusually high number of typographical errors may be indication that a user's state has deviated from a normal health-related state. Another instance may be that the control logic 221 and features module 223 may determine that a user's location at a hospital means that the user is more likely to have a medical condition, than simply be inattentive or distracted.

In another embodiment, the control logic 221 and features module 223 may determine which features to use in creating a vector. For instance, the control logic 221 and features module 223 may determine a device's capabilities or resource availability. For example, a control logic 221 and features module 223 may determine that a device has camera and audio functionality. Then, the control logic 221 and features module 223 may determine that the device may employ audio information analysis as a feature for vector creation. The control logic 221 and features module 223 may further determine that the camera may provide image information to supplement location or context information. In another embodiment, the control logic 221 and features module 223 may determine the features based on power consumption. For instance, audio analysis may require more power consumption than monitoring location data. Then, the control logic 221 and features module 223 may cause monitoring of location data for a feature vector only, and prompt audio information analysis only where the control logic 221 determines that a user has deviated from a normal health-related state.

In one embodiment, the control logic 221 and the history module 225 may determine generic behavioral models as well as historic user actions in relation to health-related states. For example, the control logic 221 and history module 223 may identify various vectors that should, based on behavioral models, indicate certain states. For example, behavioral models may show that users that drop their phones often are often intoxicated. The control logic 221 and history module 225 may determine a standard for expected vectors for features associated with each health-related state.

In one embodiment, the control logic 221 and user module 227 may determine normal feature vectors specific to particular users. In one embodiment, the control logic 221 and history module 225 may give the collection of generally expected vectors associated with each state. Then, the control logic 221 and user module 227 may determine, for a specific user, normal or expected feature vectors specific to each user. For instance, the control logic 221 and history module 225 may identify 15% error rate in keystrokes as indication of a user not being in a normal health-related state. However, a user whose hands are too large for a virtual keyboard may frequently mistype words to the point where his error rate is 25%, even when he is in a normal health-related state. Then, control logic 221 and user module 227 would determine feature vectors that reflect the user's normal state and expected feature vectors for states other than the normal state. In one such embodiment, the control logic 221 and user module 227 may monitor a user interaction over a period of time and update feature vectors that indicate a user's health-related state based on the monitoring. In a further embodiment, the feature vectors may comprise trusted information, where the user interaction information is stored and possibly accessible at a later date for trend analysis. In one embodiment, trusted information may include information where the probability of classification being correct is over 98%. For example, the control logic 221 may determine that a typing speed of 20 words per min (wpm) is correctly indicative of a user's inattentive state over 98% of the time. This would make the association between 20 wpm and an inattentive state, trusted information. Then, the control logic 221 and user module 227 may permit processing of trusted information associated with the monitoring and/or user interaction information to help determine updates in classification of user states.

In one embodiment, the control logic 221 and construction module 229 may create the feature vector for a user's current health-related state. For example, the control logic 221 and construction module 229 may determine sensor information with control logic 201 and sensor module 203, then generate the feature vector that may describe the actual, current status of a user's health-related state. In one embodiment, the control logic 221 and construction module 229 may communicate with the control logic 201 and classification module 209 for the control logic 201 and classification module 209 to classify the user's health-related state based on one or more feature vectors determined by the control logic 221 and construction module 229.

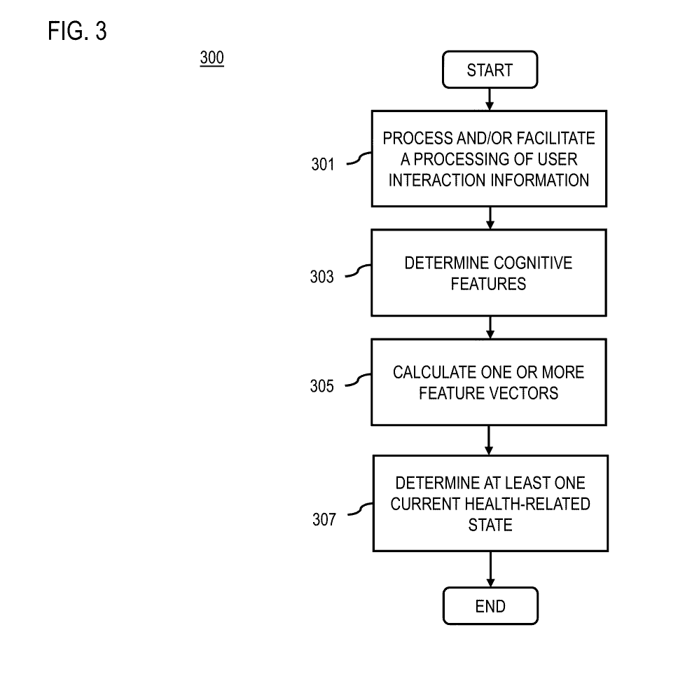

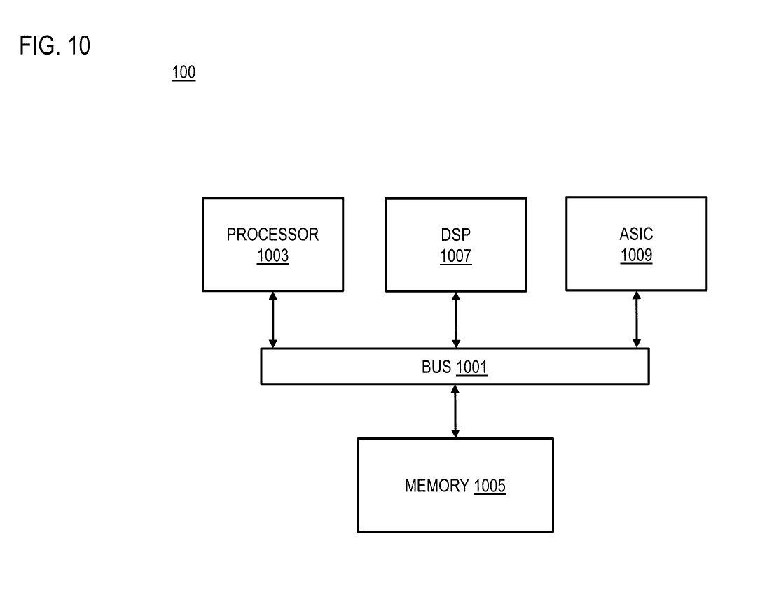

FIG. 3 is a flowchart of a process for distinguishing between various user health-related states based on user interaction information, according to one embodiment. In one embodiment, the control logic 201 performs the process 300 and is implemented in, for instance, a chip set including a processor and a memory as shown in FIG. 10. In step 301, the control logic 201 may process and/or facilitate a processing of user interaction information associated with at least one device to determine one or more cognitive features of at least one user. For example with step 303, the control logic 201 may determine the cognitive features of at least one user by determining associations between user interaction information and cognitive features. For instance, sloppy typing may indicate some impairment of motor skills in a user. Steps 301 and 303 may further include determining sensor information, contextual information, or a combination thereof associated with the user interaction information, the at least one device, the at least one user, or a combination thereof. In step 305, the control logic 201 cause, at least in part, a calculation of one or more feature vectors based, at least in part, on the one or more cognitive features.

For step 307, the control logic 201 may determine at least one current health-related state associated with the at least one user based, at least in part, on the one or more feature vectors. Where control logic 201 takes into account sensor information contextual information, or a combination thereof, the case may include a situation wherein the one or more cognitive features, the one or more feature vectors, the at least one current health-related state, or a combination thereof is further based, at least in part on the sensor information, the contextual information, or a combination thereof. For example, the control logic 201 may determine that an increase in keystroke errors as seen from feature vectors is indicative of a state of inattention. Feature vectors that show a heighted percentage of keystroke errors may cause control logic 201 to infer a state of intoxication. Furthermore, control logic 201 may cause, at least in part, an initiation of one or more actions at the at least one device, one or more other devices, or a combination thereof based, at least in part, on the at least one current health-related state. For example, the control logic 201 may cause, at least in part, dissemination of knowledge of a user's state to services that may offer advertisements to the user based on the state. For instance, a user that is in a state of intoxication may then receive advertisements from restaurants and bars.

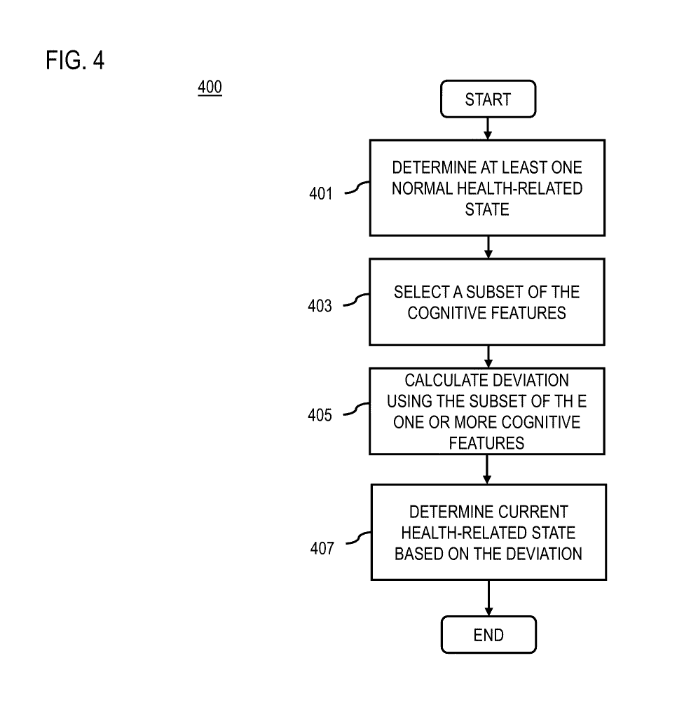

FIG. 4 is a flowchart of a process for determining normal health-related states, according to one embodiment. In one embodiment, the control logic 201 performs the process 400 and is implemented in, for instance, a chip set including a processor and a memory as shown in FIG. 10. In step 401, the control logic 201 may determine at least one normal health-related state associated with the at least one user. For example, the control logic 201 may cause, at least in part, a selection of a subset of the one or more cognitive features. In one case, the control logic 201 may cause, at least in part, an initiation of the selection of the subset based, at least in part, on resource availability information, device capability information, or a combination thereof associated with the at least one device.

In one embodiment, the control logic 201 may execute step 405, where the control logic 201 may process and/or facilitate a processing of the user interaction information to determine at least one deviation from the at least one normal health-related state. In one instance, step 405 may include causing, at least in part, a calculation of the at least one deviation using the subset of the one or more cognitive features. In one case, step 405 may further include a case where, if the at least one deviation calculated using the subset is statistically significant, the control logic 201 may cause, at least in part, a re-calculation of the deviation using a full set of the one or more features. Step 407 may include determination of the current health-related state wherein the determination of the at least one current health-related state is based, at least in part, on the at least one deviation.

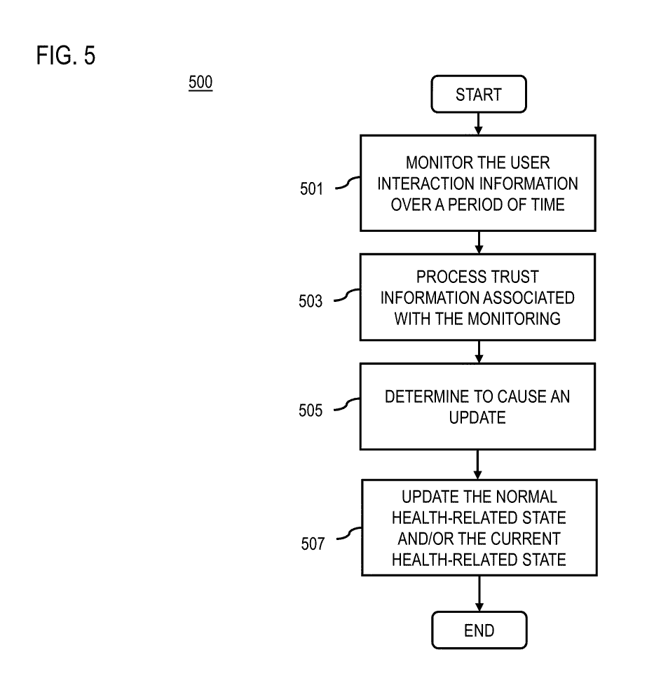

FIG. 5 is a flowchart of a process for updating the health-related states, according to one embodiment. In one embodiment, the control logic 201 performs the process 500 and is implemented in, for instance, a chip set including a processor and a memory as shown in FIG. 10. For step 501, the control logic 201 may cause, at least in part, a monitoring of the user interaction information over a period of time. In one embodiment, the control logic 201 may then execute steps 503 and 505, where the control logic 201 may process and/or facilitate a processing of trusted information associated with the monitoring, the user interaction information, or a combination thereof to determine whether to cause, at least in part, the updating of the at least one normal health-related state, the at least one current health-related state, or a combination thereof. For example, the control logic 201 may extract or retrieve trusted information from the content providers 111 and/or services 109. Based on the determination in step 505, the control logic 201 may cause, at least in part, an updating of the at least one normal health-related state, the at least one current health-related state, or a combination thereof based, at least in part, on the monitoring (step 507).

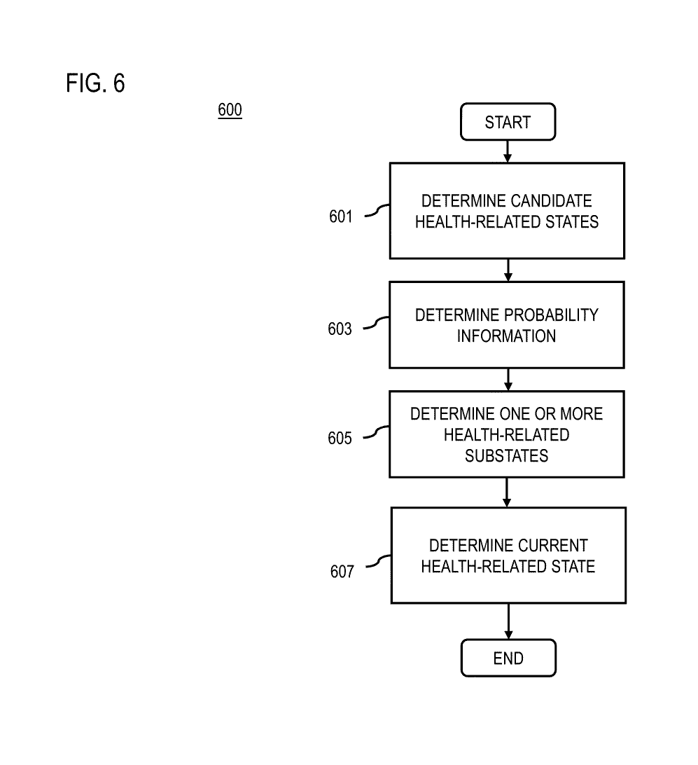

FIG. 6 is a flowchart of a process for determining the likelihood of current health-related states relative to candidate health-related states, according to one embodiment. In one embodiment, the control logic 201 performs the process 600 and is implemented in, for instance, a chip set including a processor and a memory as shown in FIG. 10. In one embodiment, the control logic 201 may determine candidate health-related states for step 601. Then with step 603, the control logic 201 may determine probability information for classifying the at least one user into one or more candidate health-related states. For step 605, the control logic 201 may determine one or more health-related substates associated with the at least one user based, at least in part, on the one or more feature vectors. For instance, the control logic 201 may determine substates as more detailed categories under the health-related states. For example, a health-related state may include “normal state” and “abnormal state.” Substates for “normal state” may include “exercising” or “at rest,” while substates for “abnormal state” may include “intoxication,” “inattention,” or “medical condition.” In another example, a health-related state may include “medical condition,” where substates are categories, for instance, “heart attack,” “asthma attack,” “allergic reaction,” etc. Then for step 607, the control logic 201 may determine the at least one current health-related state based, at least in part on the one or more health-related substates. Similarly or additionally, the control logic 201 may determine the at least one current health-related state from among the one or more candidate health-related states based, at least in part, on the probability information.

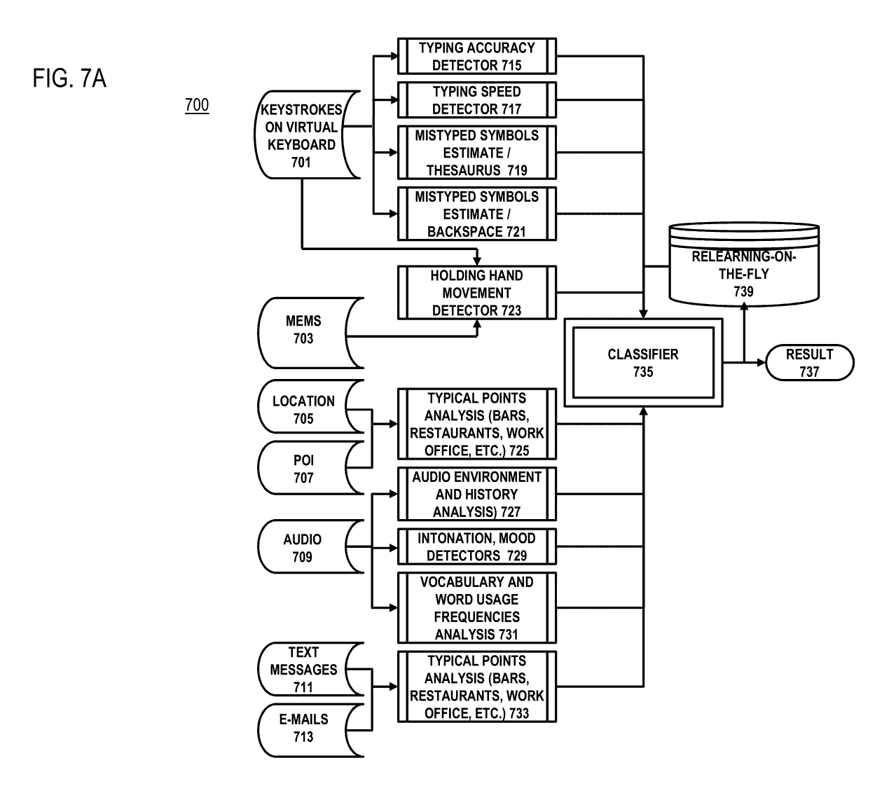

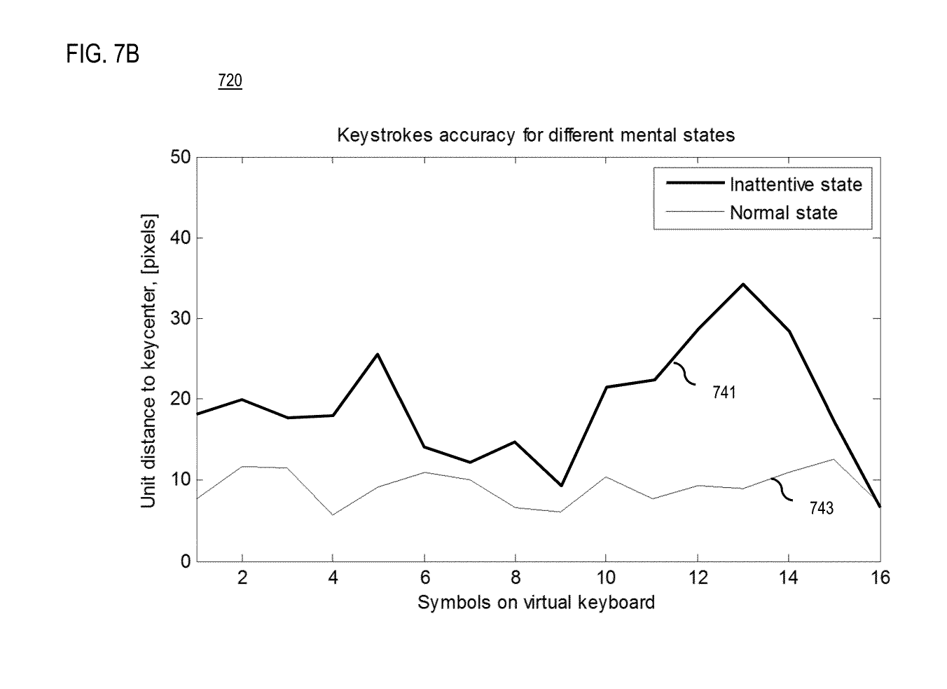

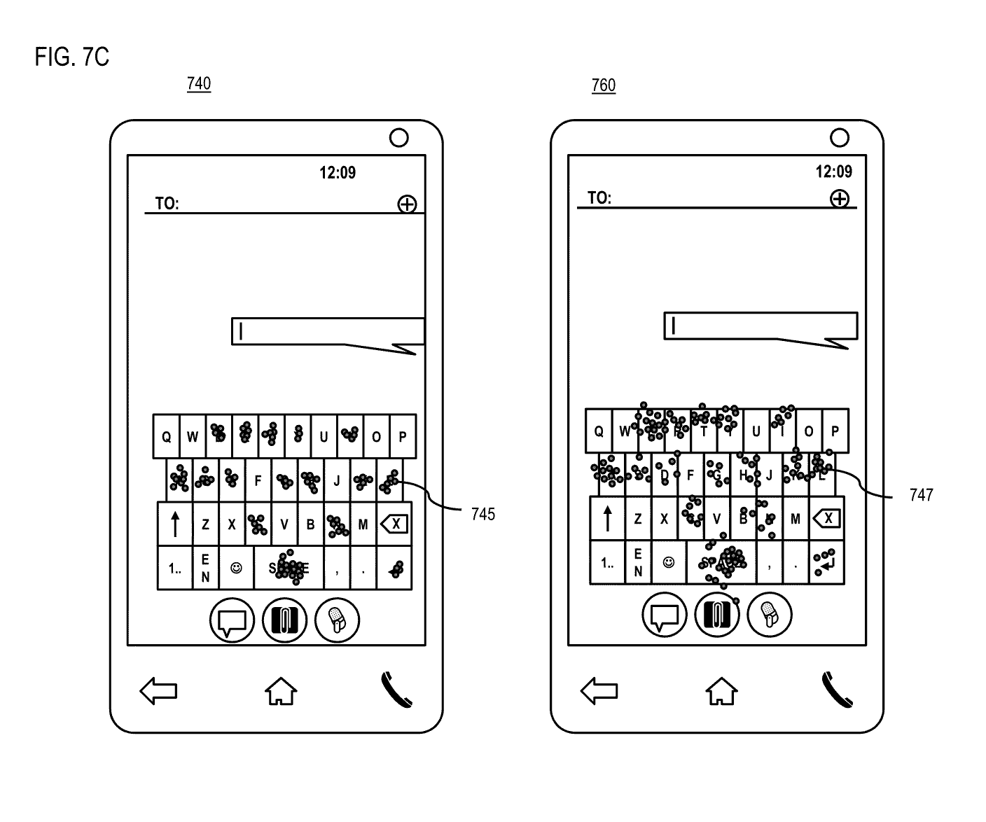

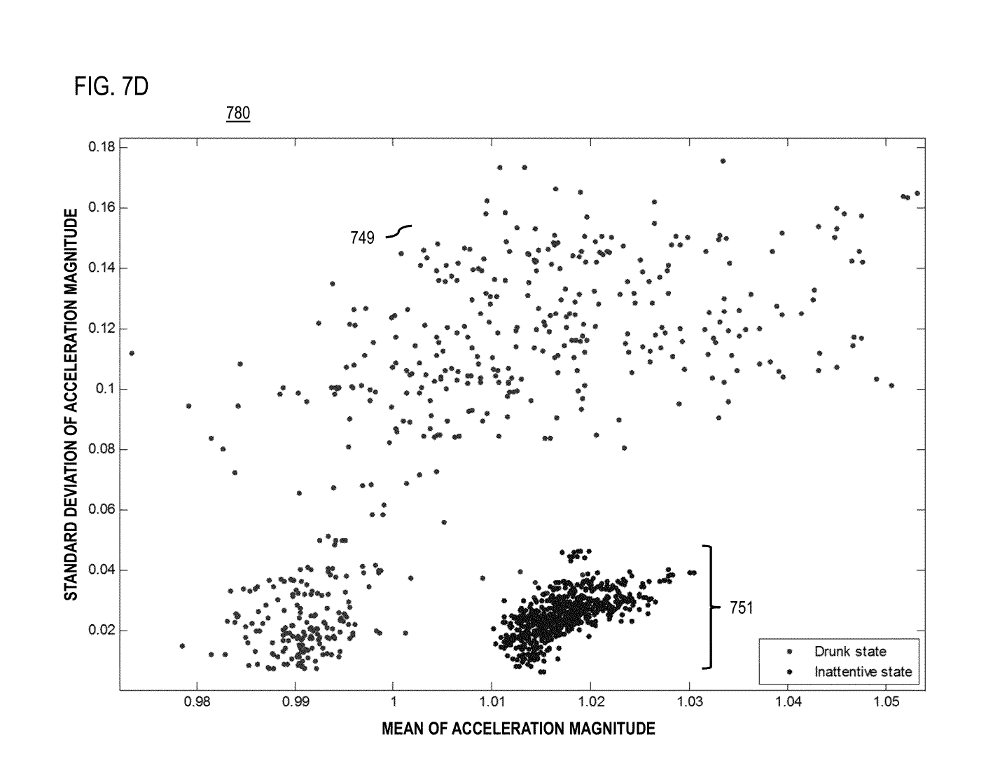

FIG. 7A is a diagram 700 of a general description of system 100, in one embodiment. In one embodiment, system 100 (and by extension, diagram 700, is composed of three main parts: 1) constructing the feature vector, 2) classifying a user's health-related state based on the features vector, and 3) continual relearning. For example, the system 100 may receive data associated with at least one device. The information may include user interaction information (i.e., keystrokes on a virtual keyboard) 701, MEMS (i.e., accelerometers and gyroscopes) 703, and sensor and/or contextual information, for instance, location information 705, point of interest (POI) information 707, audio information from a microphone 709, and text analysis (i.e., text messages 711 and emails 713). From this data, the system 100 may proceed to calculating and creating feature vectors.

For example, user interaction information 701 may include typing accuracy detector 715. For instance, typing accuracy detector 715 may determine where a user strikes a key, for example, whether a user swipes across a screen to contact a key, hits the key directly on the center of a key, or hits edges of the key. User interaction information 701 may further include typing speed detector 717 to determine a user's current and/or expected typing speed. Mistyped symbols estimate based on the thesaurus 719 and mistyped symbols estimate based on “backspace” key presses 721 are estimates of how many typographical errors or missteps a user takes. Data from MEMS 703 may relate to a detector, for example, a holding hand movement detector 723. For example, holding hand movement detector 723 may determine sudden or irregular patterns of movement for user's hand holding a device. For instance, sharp, repeated movement detected by MEMS 703 may signal that a user is undergoing a seizure. MEMS 703 may also determine movement separate from a user, for example, if a device is thrown or dropped a number of times in a small time interval.

Location information 705 and POI information 707 may include typical points analysis 725 where system 100 determines typical locations (i.e., bars, restaurants, work, office, etc.). Audio information 709 may yield a feature vector for audio environment and history analysis 727 to make inferences on a user's location, mood, and/or behavioral patterns based on the audio environment and history of user behavior. The audio information 709 may further help create feature vectors based on intonation and mood detectors 729, as well as vocabulary and work usage frequencies analysis 731. For text messages 711 and emails 713, the typical points analysis 733 may be derived from contextual clues and/or direct information from the text messages 711 and emails 713. For example, if a text says that a user is returning home, the system 100 may determine that a user is somewhere between his starting point and his home. Direct information may include a user directly texting the address of a restaurant where the user is waiting.

In one embodiment, the classifier 735 then processes the feature vectors. For example, the classifier 735 may determine feature vectors representing normal health-related states, especially normal health-related states for a particular user. Then, the classifier 735 may compare current feature vectors to the feature vectors for normal health-related states to render a result 737. The result 737 may be the user's current health-related state. In one embodiment, the system 100 may further update feature vectors, normal health-related states, and current health-related states. This component may include relearning-on-the-fly 739, or continual relearning to ensure that system 100 has the most up-to-date, accurate information and analysis of a user. For example, a user that breaks his arm may suddenly experience a drop in the accuracy of his keystrokes as he adapts to his cast. The system 100 may learn with the typing accuracy detector 715 that the user has some mobile ability impaired, rather than inferring the drop in accuracy as the user being in a state of being affected by a medical condition.

FIG. 7B is a graph 720 of extracting features from typing user interaction information, in one embodiment. In one embodiment, the graph 720 may represent keystrokes accuracy for different health-related states. For example, system 100 may extract features from keystrokes typed based on the following information: keystroke accuracy (i.e., the difference between position of finger pressing a symbol and the center coordinates of the symbol on a keyboard, typing speed for some frequent letter combinations, and number of typographical errors, either from thesaurus statistics or from number of backspace presses. In one case, system 100 may simply use simple metrics to convert the features into a numerical representation. In one embodiment, data 741 represents keystrokes accuracy for a person in an inattentive state, whereas data 743 shows keystrokes accuracy for a person in a normal health-related state. System 100 may derive data 743 from experiments and/or theoretical knowledge showing that users render different results for these features when they are in different health-related states.

FIG. 7C shows models 740 and 760 of differences in keystroke accuracy for different health-related states, as projected onto a mobile device. For example, each data point 745 stands for a keystroke, or where a user makes contact with a key. Model 740 shows an example of a normal mental or health-related state, where user interaction information by way of data point 745 strikes symbol keys substantially at the center of the keys. Model 760 is an instance of user interaction information with data points 747, where a user may be in an inattentive state. As apparent from model 760, data points 747 are substantially less concentrated and farther from hitting approximately at the center of symbol keys. In one embodiment, system 100 may employ a calculation as to when the difference between data points 745 from model 740 and data points 747 from 760 are significant enough to constitute a classification of the user's state for model 760 as being an inattentive state.

As previously discussed, after determining user interaction information as shown with models 740 and 760 as examples, system 100 may perform cross-correlation analysis or analysis of mutual hand movement during typing. For example, system 100 may perform the analysis based on MEMS data coupled to virtual keyboard typing data. Theoretical knowledge supported by experiments has shown that spatial motion of a mobile device in the hand of a user during typing depends on different health-related states of a user. Thus, system 100 may determine characteristics of the spatial motion of a mobile device by analyzing data from MEMS sensors (i.e., accelerometers and gyroscopes) to further help determine users' current health-related state. In one embodiment, the quantitative characteristic of holding hand spatial motion or holding hand movement detection may be part of a feature vector for distinguishing between different states.

FIG. 7D is a graph 780 of how different states may appear in a two-dimensional feature space including mean and standard deviation values. For instance, data points 749 may represent data for users in an intoxicated state, while the cluster of data points 751 may represent data associated with users in an inattentive state. The data points 749 and 751 may serve as default or starting feature vectors for user analysis. As seen from graph 780, recognizing and distinguishing between health-related states involves probabilistic estimation. In this regard, different features may supplement analysis. For instance after determining user interaction information, system 100 may incorporate analysis of location information to improve determination of a health-related state. For example, location information analysis may reinforce a classification indicated by user interaction information or detract from the likelihood of the accuracy of the classification. Using various features and/or feature vectors together in analysis may improve general probabilistic estimation. For example, system 100 may interpret a user staying in a restaurant or bar as increasing the probability that a user is in a drunken state whereas the same keystroke information while a user is driving for the last two hours, may be interpreted as increasing the probability of an inattentive state. In one case, system 100 may perform the location information analysis by creating feature vector components as quantitative estimates for each known typical places predefined as part of an algorithm.

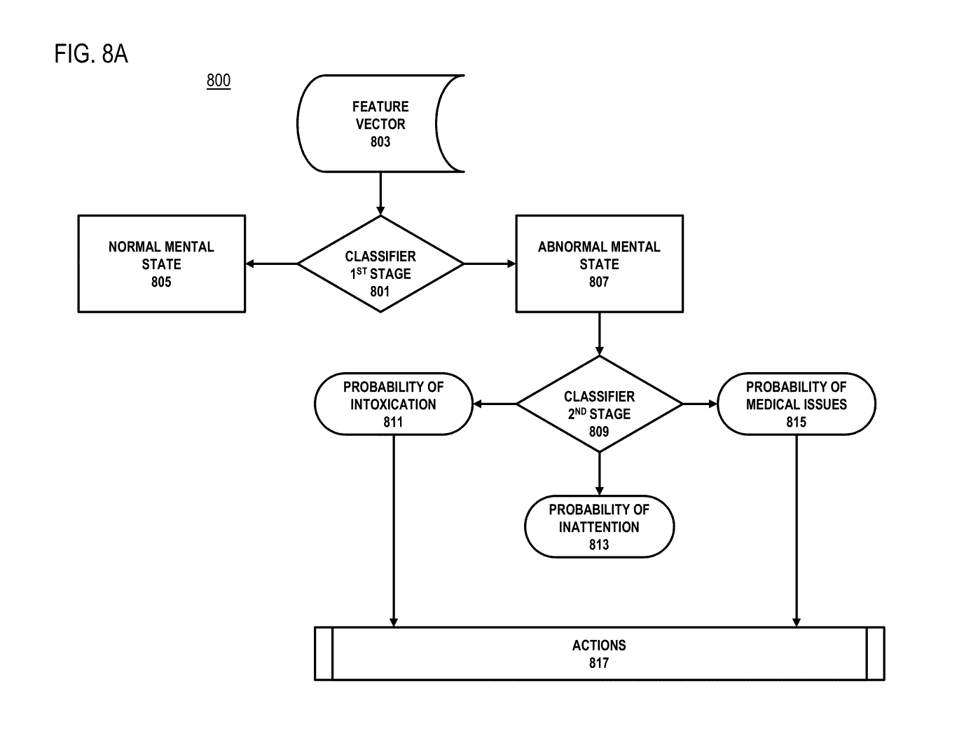

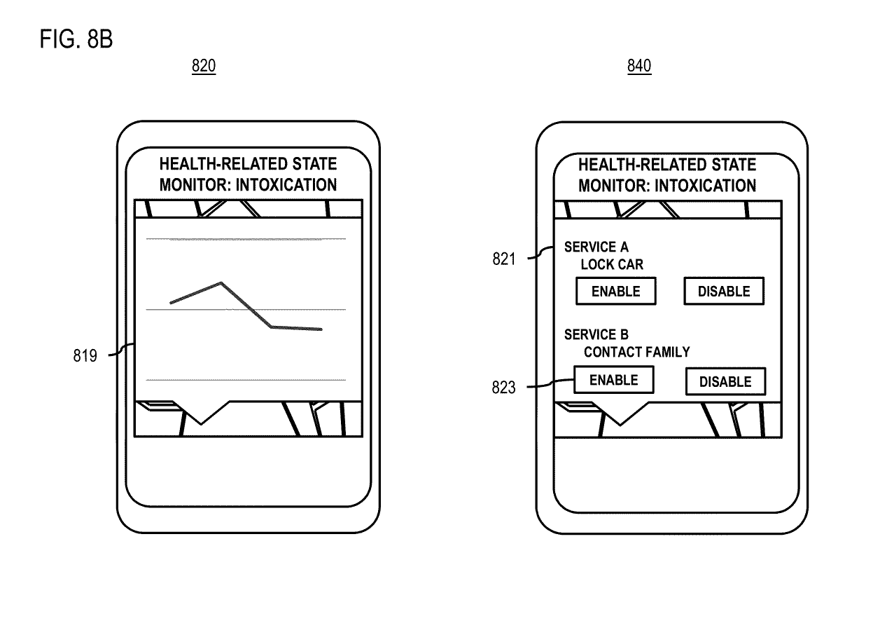

FIG. 8A is a diagram 800 for the classification procedure, in one embodiment. In one embodiment, the classification is to distinguish between distinct health-related states associated with a user. In one instance, system 100 may perform classification in two steps. First, the system 100 in classifier first stage 801 may receive a feature vector 803 as input. The classifier first state 801 may define normal health-related states 805, especially normal health-related states for a particular user. As an extension, classifier first state 801 may also define abnormal health-related states 807. For example, abnormal health-related states 805 may be abnormal mental states. In one instance, system 100 may define abnormal or unusual conditions in general. In one case, this may include values that are feature vector characteristics that are unexpected, given a particular user's demographic and income. After first determining that a user is possibly experiencing an abnormal health-related state, system 100 may move to classifier second stage 809, where more concrete substates are determined with their probabilities, given the input from feature vector 803. For example, substates may include more detail on the state of being “abnormal.” For instance, substates may comprise of probability of intoxication 811, probability of inattention 813, and probability of medical issues 815. In one embodiment, the determination of substate may further prompt an action 817. Action 817 may include, for example, issuing some warning to the user, information medical personnel, preventing the user from driving, etc. In one embodiment, either classifier 801 or 809 may be pre-trained with default data. System 100 may continually update the classifiers 801 and 809. For instance, system 100 may employ a kNN classifier. Then, the switch factor for launching the classifier may be keystrokes, although system 100 may also permit other sensor information to initiate classifier analysis.

In one embodiment, system 100 may store results of classification as trusted information so that the classifiers 801 and 809 may continually relearn how various factors contribute to a user's health-related state. For example regarding different keystrokes, different people may have different typing speed and accuracy. Each user may also have unique characteristics regarding movement of hands while typing or in talking. Relearning in system 100 is thus necessary to improve the results of the classification. In one embodiment with using a kNN classifier, system 100 may add new training data to the classifiers by receiving trusted information during operation. System 100 may further determine a reference base for true classes from trusted information from user feedback. Where resources are limited, system 100 may remove the oldest and/or least trusted data from a kNN classifier dataset so that relearning in the classifier may be done on-the-fly, without draining device resources.

FIG. 8B presents user interfaces 820 and 840 for notifying users of health-related states, in one embodiment. For user interface 800, system 100 may present a chart of changes to physiological states. For example, chart 819 may show a trend of when system 100 detected a state of intoxication, either in terms of levels of intoxication or frequency of detection of intoxication. User interface 820 may include an overview 821 of actions associated with a health-related state for various services. For example, user interface 820 may include a display listing various services and how a service may respond to an identified health-related state. Users may then elect to enable and/or disable the sharing, for example, with enable button 823. In one embodiment, users may be presented with user interface 820 as part of initiation of a service, for example, where a user enters his initial settings. In the alternative, user interface 820 may appear where a user wants to see a summary of modifications and possibly reset sharing requirements. In a further embodiment, user interface 820 may include duration and/or display preferences for various services' modifications.

The processes described herein for adapting privacy profiles to respond to changes in physiological states may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

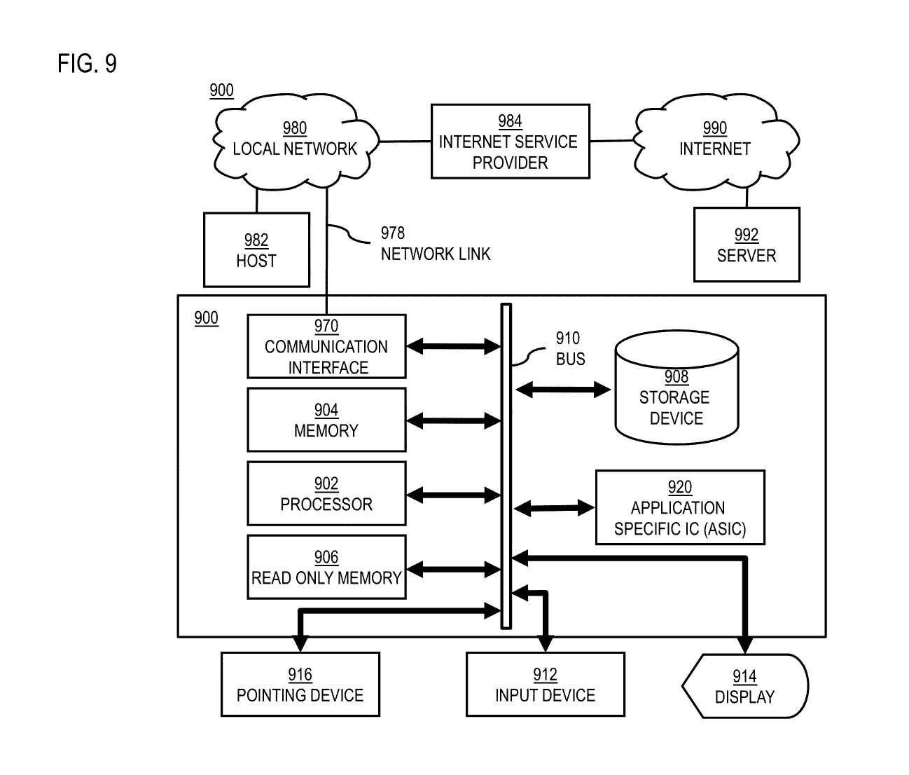

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to distinguish between various user health-related states based on user interaction information from mobile devices as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of distinguishing between various user health-related states based on user interaction information from mobile devices.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to distinguishing between various user health-related states based on user interaction information from mobile devices. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 900 also includes a memory 904 coupled to bus 910. The memory 904, such as a random access memory (RAM) or any other dynamic storage device, stores information including processor instructions for distinguishing between various user health-related states based on user interaction information from mobile devices. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for distinguishing between various user health-related states based on user interaction information from mobile devices, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914, and one or more camera sensors 994 for capturing, recording and causing to store one or more still and/or moving images (e.g., videos, movies, etc.) which also may comprise audio recordings. In some embodiments, for example, in embodiments in which the computer system 900 performs all functions automatically without human input, one or more of external input device 912, display device 914 and pointing device 916 may be omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for distinguishing between various user health-related states based on sensor information from mobile devices to the UE 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to distinguish between various user health-related states based on sensor information from mobile devices, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of distinguishing between various user health-related states based on user interaction information from mobile devices.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to distinguish between various user health-related states based on user interaction information from mobile devices. The memory 1005 also stores the data associated with or generated by the execution of the inventive steps.

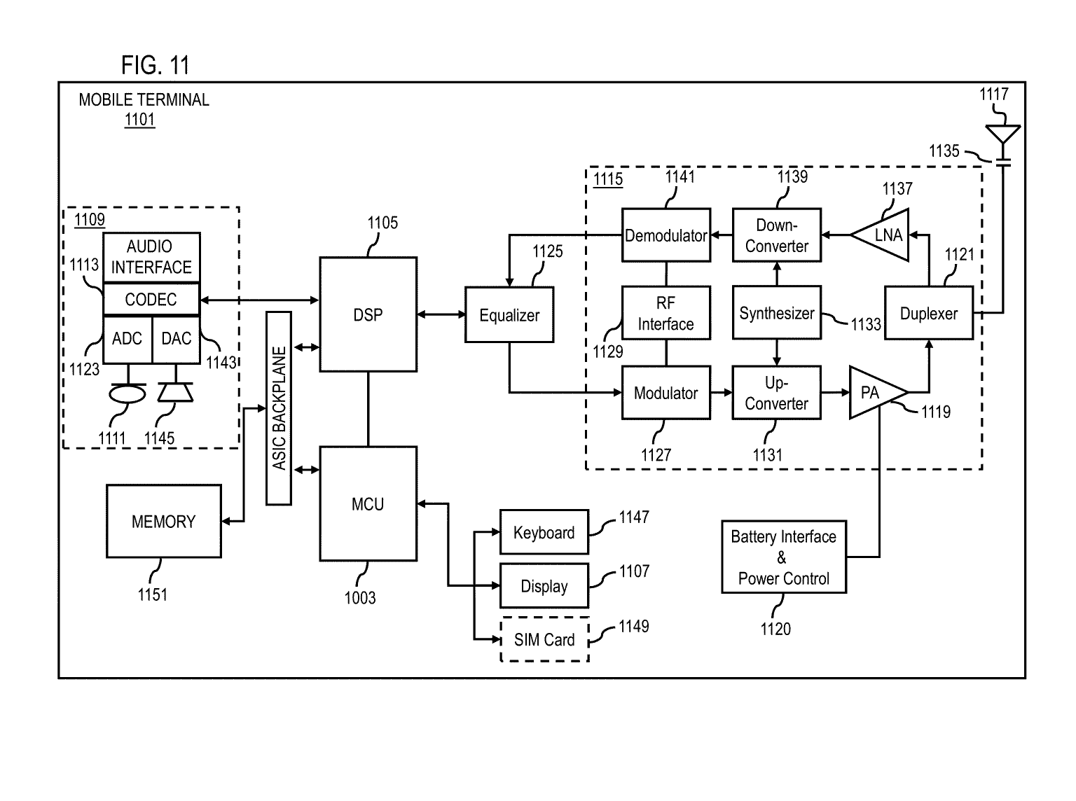

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of distinguish between various user health-related states based on user interaction information from mobile devices. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of distinguishing between various user health-related states based on user interaction information from mobile devices. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to distinguish between various user health-related states based on user interaction information from mobile devices. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

Further, one or more camera sensors 1153 may be incorporated onto the mobile station 1101 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. An apparatus comprising:
at least one processor; and
at least one memory including computer program code for one or more programs,
the at least one memory and the computer program code configured to, with the at least one processor, cause the apparatus to perform at least the following,
process and/or facilitate a processing of user interaction information associated with at least one device to determine one or more cognitive features of at least one user;
cause, at least in part, a calculation of one or more feature vectors based, at least in part, on the one or more cognitive features; and
determine at least one current health-related state associated with the at least one user based, at least in part, on the one or more feature vectors.

2. An apparatus of claim 1, wherein the apparatus is further caused to:
determine sensor information, contextual information, or a combination thereof associated with the user interaction information, the at least one device, the at least one user, or a combination thereof,
wherein the one or more cognitive features, the one or more feature vectors, the at least one current health-related state, or a combination thereof is further based, at least in part, on the sensor information, the contextual information, or a combination thereof.

3. An apparatus of claim 1, wherein the apparatus is further caused to:
determine at least one normal health-related state associated with the at least one user;
process and/or facilitate a processing of the user interaction information to determine at least one deviation from the at least one normal health-related state,
wherein the determination of the at least one current health-related state is based, at least in part, on the at least one deviation.

4. An apparatus of claim 3, wherein the apparatus is further caused to:
cause, at least in part, a selection of a subset of the one or more cognitive features;
cause, at least in part, a calculation of the at least one deviation using the subset of the one or more cognitive features; and
if the at least one deviation calculated using the subset is statistically significant, cause, at least in part, a re-calculation of the deviation using a full set of the one or more features.

5. An apparatus of claim 4, wherein the apparatus is further caused to:
cause, at least in part, an initiation of the selection of the subset based, at least in part, on resource availability information, device capability information, or a combination thereof associated with the at least one device.

6. An apparatus of claim 3, wherein the apparatus is further caused to:
cause, at least in part, a monitoring of the user interaction information over a period of time; and
cause, at least in part, an updating of the at least one normal health-related state, the at least one current health-related state, or a combination thereof based, at least in part, on the monitoring.

7. An apparatus of claim 6, wherein the apparatus is further caused to:
process and/or facilitate a processing of trusted information associated with the monitoring, the user interaction information, or a combination thereof to determine whether to cause, at least in part, the updating of the at least one normal health-related state, the at least one current health-related state, or a combination thereof.

8. An apparatus of claim 1, wherein the apparatus is further caused to:
determine one or more health-related substates associated with the at least one user based, at least in part, on the one or more feature vectors; and
determine the at least one current health-related state based, at least in part, on the one or more health-related substates.

9. An apparatus of claim 1, wherein the apparatus is further caused to:
determine probability information for classifying the at least one user into one or more candidate health-related states; and
determine the at least one current health-related state from among the one or more candidate health-related states based, at least in part, on the probability information.

10. An apparatus of claim 1, wherein the apparatus is further caused to:
cause, at least in part, an initiation of one or more actions at the at least one device, one or more other devices, or a combination thereof based, at least in part, on the at least one current health-related state.

11. A method comprising:
processing and/or facilitating a processing of user interaction information associated with at least one device to determine one or more cognitive features of at least one user;
causing, at least in part, a calculation of one or more feature vectors based, at least in part, on the one or more cognitive features; and
determining at least one current health-related state associated with the at least one user based, at least in part, on the one or more feature vectors.

12. A method of claim 11, further comprising:
determining sensor information, contextual information, or a combination thereof associated with the user interaction information, the at least one device, the at least one user, or a combination thereof,
wherein the one or more cognitive features, the one or more feature vectors, the at least one current health-related state, or a combination thereof is further based, at least in part, on the sensor information, the contextual information, or a combination thereof.

13. A method according to claim 11 further comprising:
determining at least one normal health-related state associated with the at least one user;
processing and/or facilitating a processing of the user interaction information to determine at least one deviation from the at least one normal health-related state,
wherein the determination of the at least one current health-related state is based, at least in part, on the at least one deviation.

14. A method according to claim 13, further comprising:
causing, at least in part, a selection of a subset of the one or more cognitive features;
causing, at least in part, a calculation of the at least one deviation using the subset of the one or more cognitive features; and
if the at least one deviation calculated using the subset is statistically significant, causing, at least in part, a re-calculation of the deviation using a full set of the one or more features.

15. A method according to claim 13, further comprising:
causing, at least in part, a monitoring of the user interaction information over a period of time; and
causing, at least in part, an updating of the at least one normal health-related state, the at least one current health-related state, or a combination thereof based, at least in part, on the monitoring.

16. A method according to claim 15, further comprising:
processing and/or facilitating a processing of trusted information associated with the monitoring, the user interaction information, or a combination thereof to determine whether to cause, at least in part, the updating of the at least one normal health-related state, the at least one current health-related state, or a combination thereof.

17. A method according to claim 11, further comprising:
determining one or more health-related substates associated with the at least one user based, at least in part, on the one or more feature vectors; and
determining the at least one current health-related state based, at least in part, on the one or more health-related substates.

18. A method according to claim 11, further comprising:
determining probability information for classifying the at least one user into one or more candidate health-related states; and
determining the at least one current health-related state from among the one or more candidate health-related states based, at least in part, on the probability information.

19. A method according to claim 11, further comprising:
causing, at least in part, an initiation of one or more actions at the at least one device, one or more other devices, or a combination thereof based, at least in part, on the at least one current health-related state.

20. A non-transitory computer-readable storage medium carrying one or more sequences of one or more instructions which, when executed by one or more processors, cause an apparatus to perform at least:
processing and/or facilitating a processing of user interaction information associated with at least one device to determine one or more cognitive features of at least one user;
causing, at least in part, a calculation of one or more feature vectors based, at least in part, on the one or more cognitive features; and
determining at least one current health-related state associated with the at least one user based, at least in part, on the one or more feature vectors.
